(19) United States
(12) Patent Application Publication
(10) Pub. No.: US 2004/0055878 A1
(43) Pub. Date: Mar. 25, 2004

(54) Anode for the electrolysis of aluminium

(76) Inventor: Zelimkhan S. Tsomaev, St. Petersburg (RU)

Correspondence Address: MOETTELI & ASSOCIES SARL, CASE POSTALE 486, AVE DE FRONTENEX 6, GEVEVA 12, CH-1211, CH

(21) Appl. No.: 10/250,627

(22) PCT Filed: Jan. 14, 2002
(86) PCT No.: PCT/GB02/00135

(30) Foreign Application Priority Data
Jan. 15, 2001 (GB) 0101028.9

(51) Int. Cl. B23H 3/04

(52) U.S. Cl. 204/286.1; 29/428

(57) ABSTRACT

An anode for the electrolysis of aluminium is disclosed. The anode comprises an electrode 10, and a head 22 for suspending the electrode and for supplying electricity to the electrode 10. A slot 14 is provided in the surface of the electrode 10. The slot 14 has a neck. Means for inserting the head 22 into the slot 14 of the electrode 10 are provided in the electrode 10. A portion of the head 22 has a larger cross-section than the neck of the slot 14. The head 22 is mounted in the slot 14 of the electrode 10 with the portion of larger cross-section below the neck of the slot 14. The head 22 is therefore retained in the slot 14 of the electrode 10 when the electrode 10 is suspended.

This invention relates to an anode for the electrolysis of aluminium. In particular, the anode is formed of a power supply head and a carbon electrode, the shape of the head and the electrode being designed to improve the electrical contact between the head and the electrode, thereby improving efficiency.

DD 284,908 teaches forming an anode from a power rail and a carbon electrode. The top of the carbon electrode has a raised cavity into which a power rail is inserted. The size of the cavity is greater than that of the power rail. The gap between the wall of the cavity and the power rail is filled with molten metal which is allowed to solidify. As the molten metal solidifies it shrinks and an air gap is formed between the solidified metal and the wall of the carbon electrode. The mechanical connection between the carbon electrode and the solidified metal, and hence the power rail, is limited to a small surface area and is mechanically weak. When the carbon electrode is suspended by the power rail in the electrolyte, the contact area between the carbon electrode and the solidified metal tends to decrease further under the weight of the carbon electrode. The small contact area and the lack of reliable electrical contact results in increased electric consumption during electrolysis. In order to reuse the power rails they must be extracted from the spent carbon electrodes. This extraction requires cast iron melting furnaces, a press for the removal of the cast-iron smelt from the power rails, magnetic separation plants to extract used cast-iron fragments from the spent carbon electrodes and large equipment for dismantling the spent anodes and installing new anodes to the electrolytic cell. These all result in an increase in the cost of production.

The present invention aims to overcome the problems associated with known anodes and to provide additional advantages.

The present invention in its various aspects is defined in the independent claims below. Advantageous features are set forth in the dependent claims.

The anode is assembled by sliding the head into the slot of the electrode. The shape of the slot in the electrode and of the head increases the area of contact between the electrode and the head. It improves mechanical and electrical contact between the head and the electrode and therefore reduces losses and improves efficiency. The shape of the slot and of the head eliminates the need to fill the gap between the head and the electrode with cast metal. Reclaiming the head is therefore much simpler, quicker and less costly than for prior art anodes. The provision of projections on the sides of the head further improves contact between the head and the electrode.

A preferred embodiment of the invention will now be described in more detail, by way of example, with reference to the accompanying drawings in which:

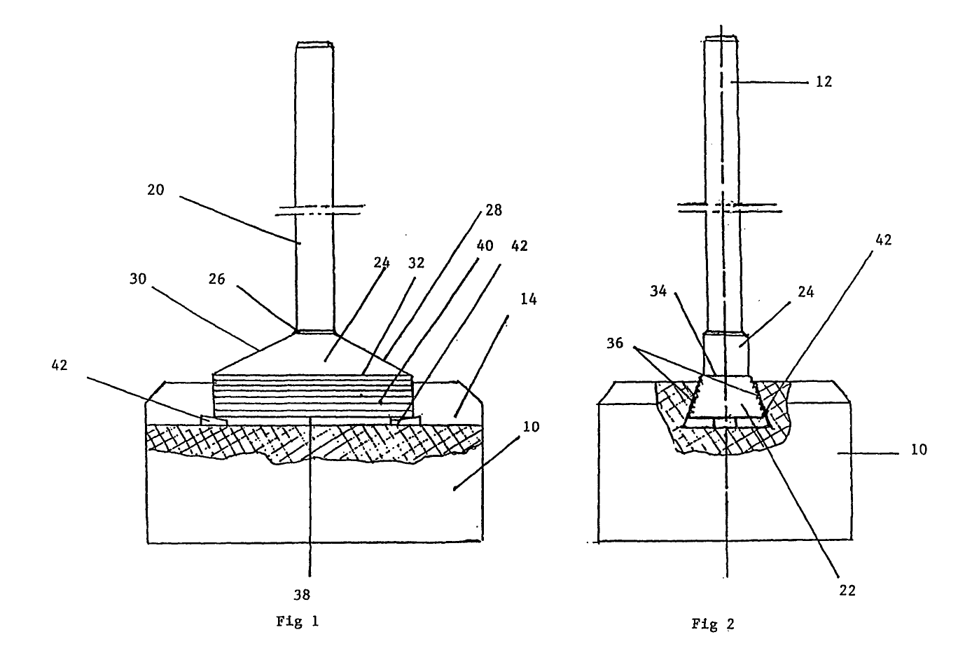

FIG. 1 is a cut away side view of an anode embodying the present invention; and

FIG. 2 is a cut away front view of the anode of FIG. 1; and

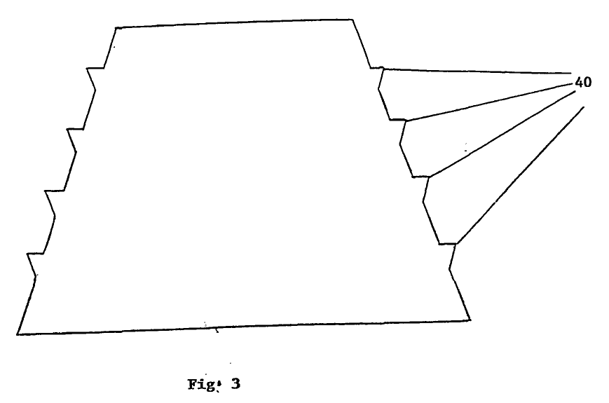

FIG. 3 is an enlarged view of the head of the anode of FIGS. 1 and 2.

FIGS. 1 and 2 show an anode embodying the present invention. The anode is formed from two parts: an electrode 10 and a power connection unit 12. The electrode 10 is formed from a rectangular block of burnt, or calcined, carbon. A slot 14 is formed in the top surface of the carbon electrode 10. The slot 14 extends axially along the entire length of the carbon electrode 10 from one side to the opposite side. The slot 14, therefore, has open ends at two sides of the electrode 10 and is open at its top. Each open end of the slot 14 provides means for inserting the head 22 into the slot 14. The depth of the slot 14 is constant. The slot 14 has a trapezoidal cross-section with the sides 16 and 18 of the slot 14 diverging towards the base of the slot. The narrow portion of the slot at the top surface of the electrode 10 defines a neck. The top and sides of the electrode 10 may be chamfered as shown in FIGS. 1 and 2.

The power connection unit 12 for supplying electricity to the electrode 10 includes a rod 20 and a head 22. The lower end of the rod 20 bears an external thread for attaching the rod 20 to the head 22. The top of the head 22 is provided with a connector 24. The base of the connector 24 is welded to the top of the head 22. The connector 24 has a double wedge shape and has sloping front and back walls 28 and 30 respectively and vertical side walls 32. The front wall 28 and back wall 30 of the connector 24 slope outwardly and downwardly from the top 26 of the connector 24 towards its base. A bore with an internal thread is provided in the centre of the top 26 of the connector 24. The rod 20 is connected to the head 22 by screwing the lower threaded end of the rod 20 into the connector 24 thus forming a good mechanical and electrical connection between the rod 20 and head 22.

The profile of the head 22 matches that of the slot 14 of electrode 10, the head 22 having a trapezoidal cross-section with the sides 36 of the head 22 diverging from the top 34 to the bottom of the head 22. The head 22 generally has a smaller cross-section than the slot 14. A portion of the head 22, in this case the bottom has a larger cross-section than the neck of the slot 14 in the electrode 10. The head 22 therefore keys in the slot 14 and once inserted into the slot 14 cannot be removed from the top of the slot 14 but may be removed by sliding it out of the open end of the slot 14. The head 22 may, therefore, be used to suspend the electrode 10 with the portion of the head 22 having larger cross-section than that of the slot 14 serving to retain the head 22 in the slot 14 when the head is suspended. The length of the head 22 is greater than the width of the head at its widest part. The head 22 is made of metal, preferably steel, and therefore has a greater thermal expansion than the carbon electrode 10. In operation, the different thermal expansions of the carbon electrode 10 and the head 22 result in an improved electrical and mechanical connection between the head 22 and the electrode 10. The shape of the head 22 in combination with the shape of the slot in the carbon electrode 10 provides an increased contact surface area thereby improving mechanical contact and reducing electrical resistance between the head 22 and the electrode 10.

As shown in FIG. 3, the sides 36 of the head 22 have parallel longitudinal ribs 40 which run the length of the head 22 and which increase the surface area of the sides 36. The ribs have sharp edges and act as barbs which cut into the carbon electrode 10. The use of sharp ribs further improves the electrical and mechanical contact during operation of the anode. The ribs 40 are preferably also metal and the head 22 may be formed with the ribs 40 or the ribs 40 may be cut into or welded onto the head 22.

The bottom 38 of the head 22 is flat. When the head 22 is disposed close to the bottom of the slot 14, the head 22 may slide freely in the slot 14.

To assemble the anode, the head 22 is aligned with the slot 14 of the electrode 10. The trapezoidal cross-section of the slot 14 is the same shape as, but is slightly larger than, the trapezoidal cross-section of the head 22. By aligning the bottom 38 of the head 22 with the bottom of the slot 14, and the sides 36 of the head 22 with the sides of the slot 14, the head 22 may be slid into the slot 14 of the electrode 10. The head 22 is prevented from rotating within the slot 14 because the length of the head 22 is greater than the width of the slot 14. The head 22 and slot 14 key together once assembled to retain the head 22 in the slot 14.

Once the head 22 has been introduced into the slot 14, fixing pins 42 are inserted underneath the bottom 38 of the head 22 to raise the head 22 within the slot 14. The neck of the slot prevents the head 22 from being removed from the slot in the vertical direction. Raising the head 22 within the slot 14 forces the sides of the head 22 to come into contact with the sloping sides of the slot 14. The contact area between the head 22 and the electrode 10 is many times larger than that of known industrial anodes and may be more than an order of magnitude larger. The electrical resistance of the head/electrode contact area is reduced which in turn reduces electric energy consumption. Contact between the head 22 and the electrode 10 is further improved by the ribs 40 biting into the sides of the slot 14.

The fixing pins 42 are made from material which burns, for example wood, or from the metal which is being recovered by electrolysis, such as aluminium, which melts so that they do not contaminate the metal production. The fixing pins 42 are wedge shaped and are inserted into the slot 14 with the narrow end towards the head 22 so that pushing the fixing pins 42 further under the head 22 in the slot 14 causes the head 22 to be raised vertically. Preferably, four wedges are used, one in each corner at the front and back of the head 22.

During the electrolysis operation, the anode or anodes are suspended by the rod 20 of the power connection unit. The rod 20 is connected to a power supply (not shown). The electrode 10 and head 22 are heated and the fixing pins 42 are expended by being burnt or melting.

The electrode 10 and head 22 are made from different materials and therefore have different thermal expansion coefficients. During operation, differences between the thermal expansion coefficients of the electrode 10 and the head 22 are accommodated by the vertical displacement of electrode 10 relative to the head 22 and by the relative shapes of the head 22 and the slot 14 in the electrode 10 which excludes the possibility of the electrode 10 being destroyed as a result of the difference between the thermal expansion coefficients of the electrode 10 and the head 22. Additionally, the ribs 40 penetrate into the electrode 10 due to the different thermal expansion coefficients of the head and electrode. These actions, separately and in combination, further improve the contact between the head 22 and the electrode 10.

The mechanical and electrical connection between the head 22 and the electrode 10 is increased during operation because the head 22 expands more than the carbon block 10 at operating temperature. The sides of the head 22 expand sideways into the electrode 10. The sharp edges of the ribs 40 also cut into the electrode 10. Additionally, the weight of the electrode 10 further causes the sloping sides 36 of the head 22 to move into the contact with the sides of the slot 14 and for the ribs 40 to bite into the electrode 10. The shape of the head 22 and the complementary shape of the slot in the electrode 10 ensure that the contact area of the head 22 and electrode 10 is maximised. Electrical resistance in the head/electrode interface is, therefore, reduced with a consequential reduction in energy consumed.

During electrolysis, the electrode 10 is oxidised. Before the bottom 38 of head 22 contacts the molten metal ore, the electrode 10 must be replaced. To replace the electrode 10, the power supply is disconnected from the rod 20 of the power connection unit 12. The anode assembly is lifted out of the electrolytic cell. The head 22 is made from metal to ensure good electrical conductivity and its rate of thermal shrinkage is more rapid than that of the carbon electrode 10. The head 22, therefore, shrinks away from the sides of the slot 14 in the electrode 10 allowing the head to be easily removed from the slot 14 of electrode 10.

The large contact area of the head with the walls of the slot of the electrode ensures that a good electrical connection is made between the electrode 10 and the head 22 of the power connection unit 12 without the need to fill the gap between the head and electrode with cast metal. Recovery of the power connection unit 12 from the spent electrode 10 is therefore much simpler, quicker and therefore less expensive. The head 22 may be reused after the electrode 10 has been consumed.

With respect to the above description, it is to be realised that equivalent apparatus is deemed readily apparent to one skilled in the art, and all equivalent apparatus to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described and accordingly, all suitable modifications and equivalents may be resorted to, falling within the scope of the invention.

For example, in alternative embodiments of the invention, the head 22 may be lifted by pulling on the rod. No fixing pins or any number of fixing pins may be used. Square or round cross-section fixing pins may be used instead of wedges. The head 22 may be formed in one piece with the rod 20 rather than in two connectable pieces. Alternative means for fixing the connector 24 to the head 22 may be provided as long as the fixing means ensures efficient flow of current from the rod 20 to the head 22. The sides of the head 22 may be stepped or a thread may be formed on the head to provide partial spiral ribs. The head 22 may be frusto-conical with a thread formed thereon. The head 22 may then rotate in the slot 14, the thread cutting into the sides of the slot 14 and providing good mechanical and electrical contact between the head 22 and the electrode 10.

Although in the preferred embodiment of the invention the slot is provided in the top of the electrode 10 allowing the electrode to be suspended vertically above the electrolytic cell by the power support rod, the slot may be provided in one or more sides of the electrode and the power supply rod could extend outwardly from the sides of the electrode 10. The slot 14 may extend from one side along only part of a surface of the electrode 14 so that the head can only be inserted into the slot from that one side. The electrode 10 may be of any shape.

Instead of the slot extending to at least one side of the electrode, a cavity, larger than the head, may be formed in the same face of the electrode as the slot, with the slot opening into the cavity. The head is inserted into the cavity, aligned with the slot opening, and slid into and along the slot. The head may then be fixed in position using fixing pins as described.

A number of heads 22 may be provided in a single electrode 10. The flow of current in the head 22 may be more accurately controlled to improve the current flow pattern and reduce energy consumption further.

Rather than ribs, small sharp projections protruding from the sides of the head may be provided. Any number and arrangement of such projections may be used. If ribs are used, they need not extend along the entire length of the sides of the head but only along a part of its length. The ribs may be non-uniform in spacing. Ribs and projections may be omitted altogether and the sides of the head may be smooth.

It should be noted that the features described by reference to particular figures and at different points of the description may be used in combinations other than those particularly described or shown. All such modifications are encompassed within the scope of the invention as set forth in the following claims.

Throughout the specification and the claims which follow, unless the context requires otherwise, the word “comprise”, and variations such as “comprises” or “including”, will be understood to imply the inclusion of a stated integer or step or group of integers or steps but not the exclusion of any other integer or step or group of integers or steps.

The reference to prior art in this specification is not, and should not, be taken as an acknowledgement or any form of suggestion that the prior art forms part of common general knowledge.

1. An anode for the electrolysis of aluminium comprising an electrode and a head for suspending the electrode and supplying electricity to the electrode, a slot being provided in a surface of the electrode, the slot having a neck, the electrode having means, communicating with the slot, for inserting the head into the slot, a portion of the head having a larger cross-section than the neck of the slot and the head being mounted in the slot with the portion of larger cross-section below the neck of the slot to retain the head in the slot when the electrode is suspended.

2. An anode according to claim 1, wherein the slot extends to at least one side of the electrode defining an open end of the slot, the open end of the slot providing the means for inserting the head into the slot.

3. An anode according to claim 1, wherein the means for inserting the head into the slot is a cavity formed in the face of the electrode, the cavity in the electrode being larger than the head and the slot extending to and communicating with the cavity.

4. An anode according to any of the preceding claims, wherein the sides of the slot are substantially the same shape as the sides of the head.

5. An anode according to claim 4, wherein the length of the head is greater than the width of the head.

6. An anode according to any of the preceding claims, wherein the slot is provided in the top of the electrode.

7. An anode according to any of the preceding claims, wherein the sides of the slot diverge from the surface of the electrode to the base of the slot.

8. An anode according to any of the preceding claims, wherein the sides of the head have one or more projections.

9. An anode according to claim 8, wherein the one or more projections are ribs.

10. An anode according to claim 9, wherein the ribs extend substantially along the length of the head.

11. An anode according to any of the preceding claims, wherein the material of the head has a higher thermal expansion coefficient than the material of the electrode.

12. An anode according to any of the preceding claims, wherein one or more fixing pins are inserted into the slot under the bottom of the head.

13. An anode according to claim 12, wherein the one or more fixing pins are made of a material which burns or melts during operation of the anode.

14. An anode substantially as hereinbefore described with reference to the accompanying drawings.

15. An electrode for ail anode comprising an electrode and a head for suspending the electrode and for supplying electricity to an electrode, wherein a surface of the electrode having a slot therein, the slot having a neck for retaining a head in the slot of the electrode when the electrode is suspended, and the electrode having means, communicating with the slot, for inserting the head into the slot.

16. An electrode according to claim 15, wherein the slot extends to at least one side of the electrode defining an open end of the slot, the open end of the slot providing the means for inserting the head into the slot.

17. An electrode according to claim 15, wherein the means for inserting the head into the slot is a cavity formed in the surface of the electrode, the cavity in the electrode being larger than the head and the slot extending to and communicating with the cavity.

18. An electrode substantially as hereinbefore described with reference to the accompanying drawings.

19. A method of making an anode for the electrolysis of aluminium, the anode comprising an electrode and a head for suspending the electrode and for supplying electricity to the electrode, the method comprising the steps of:
(1) forming a slot in a surface of the electrode, the slot having a neck;
(2) forming means in the electrode for inserting the head of the anode into the slot in the electrode, the means for inserting the head into the slot communicating with the slot;
(3) inserting the head into the means for inserting the head into the slot; and
(4) aligning the head with the slot of the electrode and sliding the head into the slot, the head being mounted in the slot with the portion of larger cross-section below the neck of the slot to retain the head in the slot when the electrode is suspended.

20. A method according to claim 19, wherein the slot extends to at least one side of the electrode defining an open end of the slot, step (c) requiring the head of the anode to be aligned with and inserted into the open end of the slot.

21. A method of assembling an anode substantially as hereinbefore described with reference to the accompanying drawings.
